(19) United States
(12) Patent Application Publication
(10) Pub. No.: US 2011/0238809 A1
(43) Pub. Date: Sep. 29, 2011

(54) METHOD OF MANAGING SELECTION INFORMATION WITH RESPECT TO MEDIA CONTENT, AND USER DEVICE, SERVICE, AND STORAGE MEDIUM FOR EXECUTING THE METHOD

(75) Inventors: Jung-shin PARK, Suwon-si (KR); Kyung-eun LEE, Suwon-si (KR); Yang-soo KIM, Yongin-si (KR); Hae-sik JUN, Seoul (KR); Young-suk KIM, Seongnam-si (KR); Jong-myeong BAN, Seoul (KR)

(73) Assignee: Samsung Electronics Co., Ltd.

(21) Appl. No.: 13/070,907

(22) Filed: Mar. 24, 2011

Related U.S. Application Data
(60) Provisional application No. 61/316,904, filed on Mar. 24, 2010.

(30) Foreign Application Priority Data
Jul. 9, 2010 (KR) 10-2010-0066415

(51) Int. Cl. G06F 15/173

(52) U.S. Cl. 709/223

(57) ABSTRACT

A method of managing selection information with respect to media content in a user device, a method of managing selection information with respect to media content in a server, the user device, a server, and a storage medium are provided. First information about at least one media content is output from the user device. A selection signal based on the first information is received at the user device. Second information about media content selected by the selection signal is transmitted from the user device to the server.

### PRIORITY

This application claims priority under 35 U.S.C. §119(e) to U.S. Provisional Patent Application No. 61/316,904, filed on Mar. 24, 2010, in the U.S. Patent and Trademark Office, and under 35 U.S.C. §119(a) to Korean Patent Application No. 10-2010-0066415, filed on Jul. 9, 2010, in the Korean Intellectual Property Office, the disclosures of which are incorporated herein by reference.

### BACKGROUND OF THE INVENTION

1. Field of the Invention

The present invention relates generally to media content distribution, and more particularly, to a method of managing selection information regarding media content, and a user device, a service, and a storage medium for executing the method.

2. Description of the Related Art

With the development of the Internet, the means for an individuals to form social relationships have changed. One such example in is a web-based Social Network Service (SNS) that allows users to share information via social media services such as blogs, twitter, me2 day, facebook, and so forth.

In particular, as real-time communication with various persons becomes possible based on social media services such as Twitter®, Me2 day®, or Facebook®, the types of SNS services have also diversified from a service allowing users to share information with other persons to a service based on users' consumption patterns.

### SUMMARY OF THE INVENTION

The present invention has been made to address at least the above problems and/or disadvantages and to provide at least the advantages described below. Accordingly, an aspect of the present invention provides a method of managing a user's selection information with respect to media content for an SNS based on a user's consumption pattern with respect to the media content, and a user device, a server, and a storage medium for executing the method.

Another aspect of the present invention provides a method of managing a user's selection information with respect to media content, which can be received in real time, and a user device, a server, and a storage medium for executing the method.

According to an aspect of the present invention, a method of managing selection information with respect to media content in a user device is provided. First information about at least one media content is output from the user device. A selection signal based on the first information is received at the user device. Second information about media content selected by the selection signal is transmitted from the user device to a server.

A selection termination signal regarding the selected media content may be transmitted to the server if output of the selected media content is terminated.

Location information of the user device may be transmitted to the server.

An SNS regarding the selection information with respect to the media content may be received, where the SNS is managed by the server.

After transmitting the second information to the server, a signal indicating maintenance of selection of the media content is periodically transmitted to the server until an output state of the selected media content is changed.

The media content selected by the selection signal may be compared with currently output media content and if the selected media content is different from the currently output media content, and a media content receiving function is controlled to output the selected media content.

According to another aspect of the present invention, a method of managing selection information with respect to media content in a server is provided. Second information about media content selected based on first information about at least one media content is received at the server from a user device. The received second information is managed, at the server, as selection information with respect to the at least one media content for the user device.

If receiving a selection termination signal regarding the selected media content from the user device, time information may be detected until receiving the selection termination signal after receiving the second information, and the selection information with respect to the at least one media content may be managed based on the time information.

Location information of the user device may be received, where the managing of the selection information includes managing location information of the received user device together with the selection information with respect to the at least one media content.

An SNS based on the selection information with respect to the media content may be provided to the user device.

Periodic reception of a signal indicating maintenance of selection of the media content may be monitored after receiving the second information, where the managing of the selection information includes using a result of the monitoring when managing the selection information.

According to an additional aspect of the present invention, a user device is provided that includes a first data transmitting and receiving unit for receiving first information about at least one media content, a user interface unit for interacting with a user, a second data transmitting and receiving unit for transmitting and receiving data with a server, and a storing unit for storing a program for managing user's selection information with respect to the at least one media content. The user device also includes a processor for outputting the first information received by the first data transmitting and receiving unit to the user interface unit. Upon receiving a selection signal based on the output first information from the user interface unit, the processor transmits second information about media content selected by the selection signal to the server through the second data transmitting and receiving unit.

The user device may further include a location information detecting unit for detecting location information of the user device, in which the processor transmits the location information to the server through the second data transmitting and receiving unit.

According to a further aspect of the present invention, a server is provided that includes a data transmitting and receiving unit for transmitting and receiving data with at least one user device, a storing unit for storing selection information with respect to at least one media content, and a processor. Upon receiving second information about media content selected based on first information about the at least one media content through the data transmitting and receiving unit, the processor instructs the storing unit to store the received second information as the selection information.

According to another aspect of the present invention, a storage medium is provided having recorded thereon a computer program for managing selection information with respect to media content in a user device. The computer program executes the steps of outputting first information about at least one media content from the user device, receiving a selection signal based on the first information at the user device, and transmitting second information about media content selected by the selection signal from the user device to a server.

Additionally, according to another aspect of the present invention, a storage medium is provided having recorded thereon a computer program for managing selection information with respect to media content in a server. The computer program executes the steps of, when receiving a selection termination signal regarding the selected media content at the server from the user device, detecting time information from reception of the second information until reception of the selection termination signal, and managing, at the server, the selection information with respect to the at least one media content based on the time information.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating a user device, according to an embodiment of the present invention;

FIG. 2 is a flowchart illustrating a method of managing selection information with respect to media content in a user device, according to an embodiment of the present invention;

FIG. 3 is a flowchart illustrating another method of managing selection information with respect to media content in a user device, according to an embodiment of the present invention;

FIG. 4 is a flowchart illustrating a further method of managing selection information with respect to media content in a user device, according to an embodiment of the present invention;

FIG. 5 is a flowchart illustrating an additional method of managing selection information with respect to media content in a user device, according to an embodiment of the present invention;

FIG. 6 is a flowchart illustrating another method of managing selection information with respect to media content in a user device, according to an embodiment of the present invention;

FIG. 7 is a block diagram illustrating a user device, according to another embodiment of the present invention;

FIG. 8 is a flowchart illustrating a method of managing selection information with respect to media content in a user device, according to another embodiment of the present invention;

FIG. 9 is a flowchart illustrating an SNS method for management of selection information with respect to media content in a user device, according to another embodiment of the present invention;

FIG. 10 illustrates an SNS-based screen for selection information with respect to media content based on a location of a user device, according to an embodiment of the present invention;

FIG. 11 is a block diagram illustrating a server, according to an embodiment of the present invention;

FIG. 12 is a flowchart illustrating a method of managing selection information with respect to media content in a server, according to an embodiment of the present invention;

FIG. 13 is a flowchart illustrating another method of managing selection information with respect to media content in a server, according to an embodiment of the present invention;

FIG. 14 is a flowchart illustrating an additional method of managing selection information with respect to media content in a server, according to an embodiment of the present invention;

FIG. 15 is a flowchart illustrating a further method of managing selection information with respect to media content in a server, according to an embodiment of the present invention; and

FIG. 16 illustrates a network system including a user device and a server, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

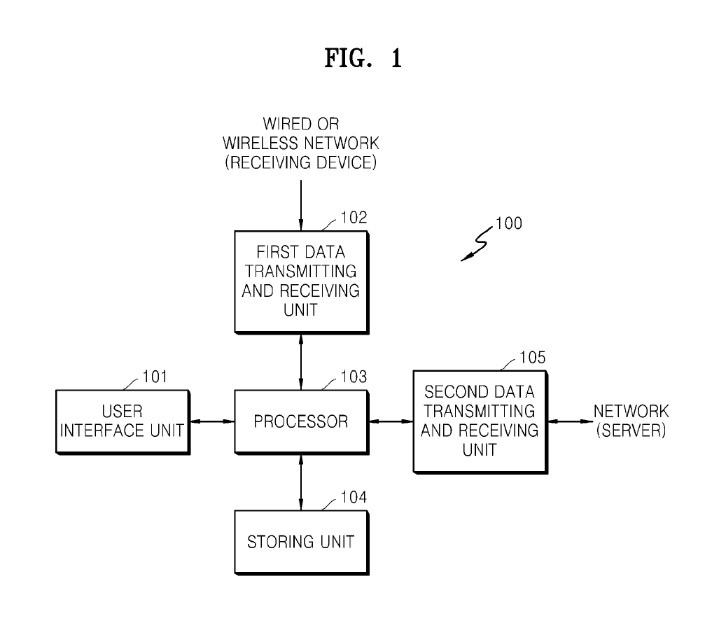

FIG. 1 is a block diagram illustrating a user device 100, according to an embodiment of the present invention. The user device 100 may be connected to a network, such as the Internet. The user device 100 may receive and output at least information about media content through a receiving device connected thereto by a wired/wireless network, and control the receiving device.

The user device 100 may be, but is not limited to, a mobile device, which may include, but is not limited to, a portable phone, an MP3 Player (MP3P), a navigation device, or a Personal Digital Assistant (PDA). The portable phone may be an android phone or an i-phone.

The information about the media content may include information capable of identifying media contents such as Television (TV) or radio broadcasting programs, electronic books, or music files. In particular, the information about the media content may be defined as information capable of identifying media content that can be received in real time through the receiving device connected to the user device 100 by a wired/wireless network. The information capable of identifying the media content may be defined as detailed information about the media content. Outputting the media content from the receiving device may be defined as reproducing or displaying the media content according to a type of the media content. The receiving device may be, but is not limited to, a device such as a TV set or a set-top box.

Referring again to FIG. 1, the user device 100 may include a user interface unit 101, a first data transmitting and receiving unit 102, a processor 103, a storing unit 104, and a second data transmitting and receiving unit 105. The first data transmitting and receiving unit 102 and the second data transmitting and receiving unit 105 may be realized as a single component.

The user interface unit 101 is a unit for interaction between the user device 10 and a user. The user interface unit 101 may input an input signal such as a touch-based signal, a key-based signal, or a mouse-manipulation-based signal, and may output information about media contents and information that can be selected by the user. The information about the media contents output by the user interface unit 101 may be defined as, but is not limited to, list information of the media contents which can be selected by the user.

The user interface unit 101 can include an input unit and an output unit. A signal input through the user interface unit 101 may be interpreted as a signal that is input through the input unit, and a signal output through the user interface unit 101 may be interpreted as a signal output through the output unit. The output unit may be a display device or a means including a display device and a speaker. Thus, the user interface unit 101 may include the input unit, the display device, and the speaker. The display device included in the user interface unit 101 may be a Liquid Crystal Display (LCD), a Light-Emitting Diode (LED), or an Active-Matrix Organic Light-Emitting Diode (AMOLED). However, the user interface unit 101 is not limited to the foregoing description.

The first data transmitting and receiving unit 102 transmits data to and receives data from the receiving device connected by the wired/wireless network. Thus, the first data transmitting and receiving unit 102 may be defined as an interface unit or a wired/wireless network interface unit between the user device 100 and the receiving device.

The first data transmitting and receiving unit 102 may receive information about at least one media content from the receiving device. The received information about the media content may be the information capable of identifying the media content or the detailed information about the media content as described above. For example, if the media content is a TV or radio broadcasting program, the information about the media content may include at least channel information and a name of the broadcasting program. If the media content is a music file, the information about the media content may include at least a title of music and a name of a singer. If the media content is an electronic book, the information about the media content may include at least a title of the book, a name of an author, a publishing company, and an International Standard Book Number (ISBN). The information about the media content may be defined as including, but is not limited to, Program and System Information Protocol (PSIP) information transmitted from a TV receiver or Enhanced TV Binary Interchange Format (EBIF) information transmitted from a set-top box.

The receiving device, for providing the information about the media content to the user device 100 through the wired or wireless network, may be a media content receiver. If the media content is a TV broadcasting program, the media content receiver may be a TV or a set-top box as stated above. When the media content is terrestrial Digital Multimedia Broadcasting (DMB) or satellite DMB, the media content receiver may be a DMB receiver.

The first data transmitting and receiving unit 102 transmits the received information about the media content to the processor 103. The processor 103 may arrange the received information about the media content in the form of a list and output the list based on the received information about the media content to the user interface unit 101. However, the form of the information about the media content output to the user interface unit 101 is not limited to the list. For convenience' sake, the information about the media content output to the user interface unit 101 will be defined as first information. The first data transmitting and receiving unit 102 may include a decoder for detecting the information about the media content from the information received through the wired/wireless network. The received information about the media content may be identical to the first information.

The processor 103 controls the overall function of the user device 100 and may be, but is not limited to, a controller or a microprocessor. The processor 103 may operate by loading a program capable of executing a method of managing selection information with respect to media content according to an embodiment of the present invention from the storing unit 104. To load the program, the processor 103 may include a temporary memory. The program may be stored in the storing unit 104 by a manufacturer of the user device 100, or may be downloaded by the processor 103 from a server, such as an App Store server, connected through the second data transmitting and receiving unit 105 in response to a user's request received through the user interface unit 101.

The processor 103 may output the first information based on the information about the media content received through the first data transmitting and receiving unit 102 to the user interface unit 101, or output the first information to the user interface unit 101 while storing the first information in the storing unit 104. The first information may be identification information of at least one content or a plurality of media contents, which can be received through the receiving device connected to the user device 100. Specifically, if the received information about the media content is guide information about a plurality of programs which can be received, such as Electronic Program Guide (EPG) information, the first information displayed on the user interface unit 101 may be defined as list-form information based on identification information (including titles of programs and channel information) about broadcasting programs that can be displayed through the receiving device connected to the user device 100. If the first information is output from the first data transmitting and receiving unit 102, the processor 103 may control the first data transmitting and receiving unit 102 to transmit the first information directly to the user interface unit 101 and the storing unit 104.

Upon reception of a user's selection signal based on the first information from the user interface unit 101, the processor 103 transmits second information about media content selected according to the received selection signal to a server connected to a network through the second data transmitting and receiving unit 105. The server is a server capable of providing an SNS, and may be a server for managing selection information with respect to the media content. The selection signal may be defined as a check-in signal. The second information is identification information of the selected media content.

If the first information is the identification information including the titles of programs and the channel information of the received media contents, the second information may be identification information including a title of a program and the channel information of the selected media content. If the first information includes titles of electronic books, names of authors of the electronic books, publishing companies, and ISBNs, the second information may be defined as identification information including a title, an author's name, a publishing company, and an ISBN of the selected media content. However, in the case of an electronic book, the second information may be identification information including only an ISBN because the server may recognize the title of the electronic book, the author's name, and the publishing company based on the ISBN. In the case of the electronic book, the first information may further include information based on previews of selectable electronic books.

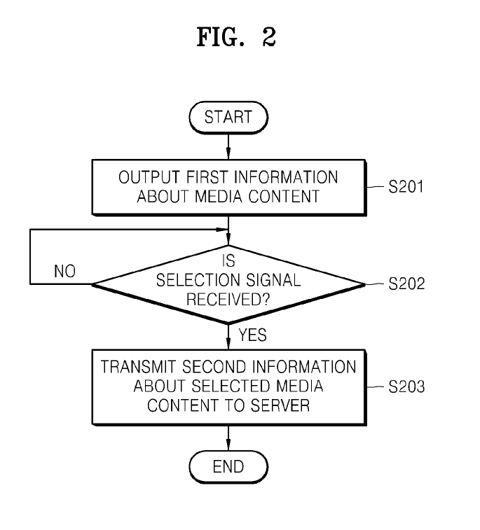

The processor 103 may operate based on the program as shown in FIG. 2. FIG. 2 is a flowchart illustrating a method of managing selection information with respect to media content in the user device 100, according to an embodiment of the present invention.

Referring to FIG. 2, the processor 103 outputs first information about at least one media content to the user interface unit 101 in block S201. The at least one media content is media content that can be received by a receiving device connected to the user device 100, and may be or may not be output from the current receiving device. For example, when the receiving device may receive media content through a plurality of channels, media content received through a channel that is not currently selected may not be output from the receiving device.

Upon receiving a user's selection signal based on the first information from the user interface unit 101 in block S202, the processor 103 transmits second information about selected media content to a server in block S203. The first information and the second information are the same as the first information and the second information described with respect to FIG. 1.

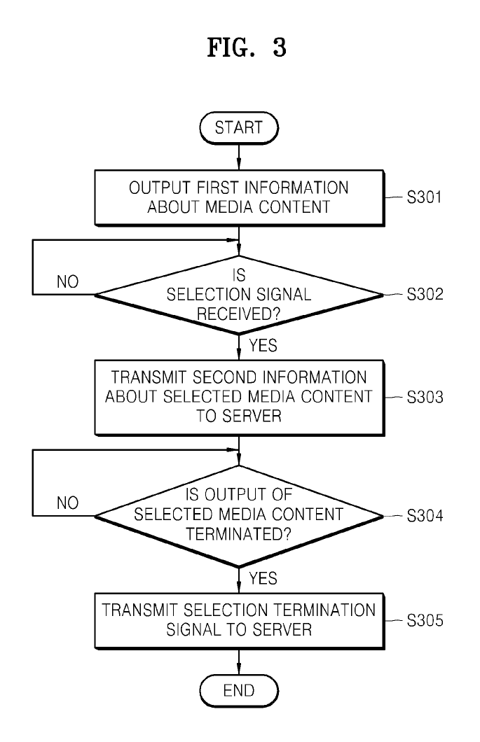

The processor 103 may manage selection information with respect to media content based on a loaded program, as shown in FIG. 3. FIG. 3 is a flowchart illustrating another method of managing selection information with respect to media content in the user device 100, according to an embodiment of the present invention.

In FIG. 3, a function at termination of output of the selected media content in the receiving device connected to the user device 100 is added to the embodiment illustrated in FIG. 2. Blocks S301 through S303 of FIG. 3 are the same as blocks S201 through S203 of FIG. 2, and thus, will not be described again.

Upon receiving an output termination signal with respect to the selected media content from the user interface unit 101 or the first data transmitting and receiving unit 102 in block S304, the processor 103 transmits the output termination signal with respect to the selected media content to the server in block S305. The output termination signal may be a check-out signal.

The output termination signal transmitted from the user interface unit 101 may be generated based on a channel change signal or a power-off signal for the user device 100. The output termination signal transmitted from the first transmitting and receiving unit 102 is a signal indicating termination of output of media content regardless of control of the user device 100, and may be received from the receiving device through a wired or wireless network. For example, if media content is a TV broadcasting program, the output termination signal may be a signal indicating termination of a TV broadcasting program or an operation-based signal such as power-off or channel change of the receiving device.

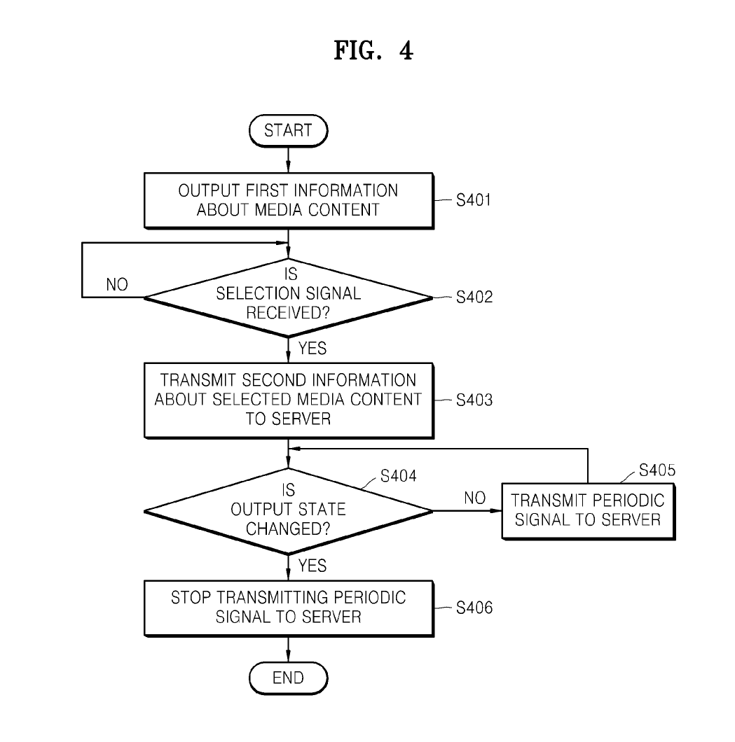

The processor 103 may manage selection information with respect to media content based on a loaded program as shown in FIG. 4. FIG. 4 is a flowchart illustrating a method of managing selection information with respect to media content in the user device 100 according to an embodiment of the present invention.

In FIG. 4, a function according to an output state of the selected media content in the receiving device connected to the user device 100 is added to the embodiment illustrated in FIG. 2. The embodiment illustrated in FIG. 4 is a modification of the embodiment illustrated in FIG. 3. Blocks S401 through S403 of FIG. 4 are the same as blocks S201 through S203 of FIG. 2, and thus, will not be described again.

After transmitting the second information to the server in block S403, the processor 103 checks if an output state of the selected media content is changed in the receiving device in block S404. The checking may be performed based on the output termination signal with respect to the media content, received by the first data transmitting and receiving unit 102 as described in FIG. 3. For example, if the output termination signal is received by the first data transmitting and receiving unit 102 due to power off or channel change of the receiving device before the output of the media content from the receiving device is normally terminated, the processor 103 may determine that the output state of the selected media content is changed in the receiving device. However, the checking may also be performed based on a signal indicating power off or channel change of the receiving device, instead of the output termination signal.

If it is determined that the output state is not changed, the processor 103 transmits a periodic signal to the server in block S405 until it determines that the output state is changed. The periodic signal may be a signal indicating maintenance of selection of media content. If it is determined that the output state is changed, the processor 103 stops transmitting the periodic signal to the server in block S406.

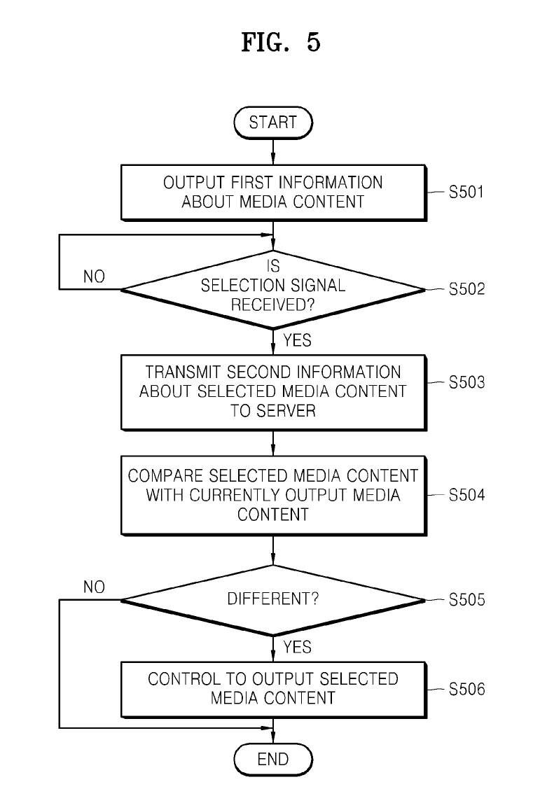

The processor 103 may manage selection information with respect to media content based on a loaded program as shown in FIG. 5. FIG. 5 is a flowchart illustrating another method of managing selection information with respect to media content in the user device 100, according to an embodiment of the present invention.

In FIG. 5, a function for a case where selected media content and currently output media content are different from each other is added to the embodiment illustrated in FIG. 2. Blocks S501 through S503 of FIG. 5 are the same as blocks S201 through S203 of FIG. 2, and thus, will not be described again.

In block S504, the processor 103 compares selected media content with media content currently output from the receiving device. If it is determined that the selected media content is different from the currently output media content in block S505, the processor 103 controls the receiving device to output the selected media content in block S506. For example, if the selected media content is a broadcasting program A received on a channel 1 and the media content currently output from the receiving device is a broadcasting program C received on a channel 3, the processor 103 transmits a signal for controlling a selection channel to the receiving device through the first data transmitting and receiving unit 102 to output the broadcasting program A of the channel 1. The comparison may use, but is not limited to, a method of comparing channel information regarding media content currently received by the receiving device, collected by the first data transmitting and receiving unit 102, and channel information regarding currently selected media content. The second information may include channel information regarding the currently selected media content, and thus, the comparison may be performed based on the second information.

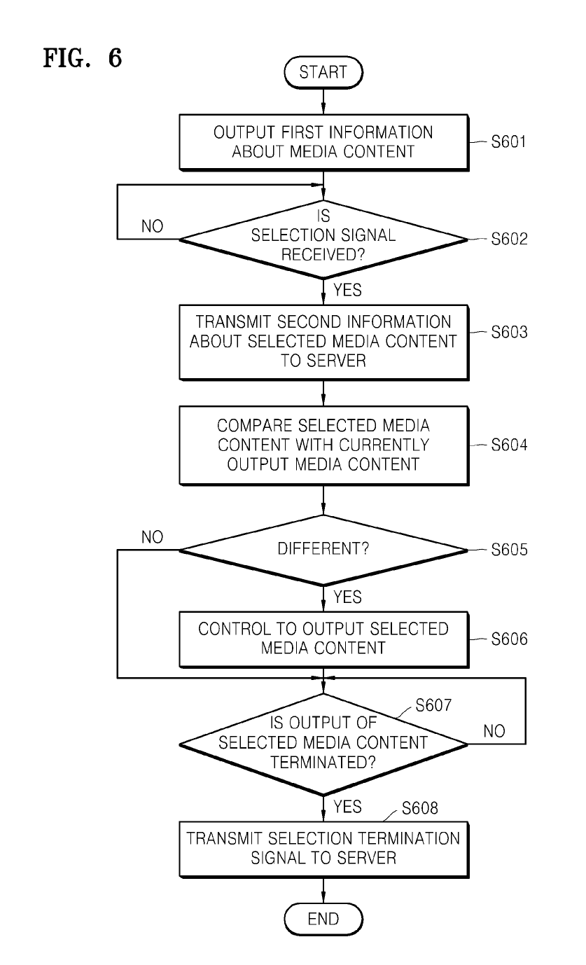

The processor 103 may manage selection information with respect to media content based on a loaded program as shown in FIG. 6. FIG. 6 is a flowchart illustrating a method of managing selection information with respect to media content in the user device 100, according to a further embodiment of the present invention.

In FIG. 6, a function at termination of output of selected media content is added to the embodiment of FIG. 5. Blocks S601 through S606 of FIG. 6 are the same as blocks S501 through S506 of FIG. 5, and thus, will not be described again.

Upon generation of the output termination signal with respect to the selected media content in block S607, the processor 103 transmits the selection termination signal with respect to the selected media content to the server in block S608. Blocks S607 and S608 may be performed in the same manner as in the foregoing blocks S304 and S305. Blocks S607 and S608 may be substituted for blocks S404 through S406 of FIG. 4.

The storing unit 104 may store at least the first information and the program according to the aforementioned embodiments. The storing unit 104 may include, but is not limited to, a flash memory having a high access speed.

The second data transmitting and receiving unit 104 allows data transmission/reception between the server connected to a network, such as the Internet, and the user device 100. The data that can be transmitted and received may include the foregoing program for implementing an embodiment of the present invention and the second information. However, a server providing the program and a server collecting the second information may be defined as different servers. The second data transmitting and receiving unit 104 may transmit and receive data through the network, and thus, may be, but is not limited to, a network interface unit. The network is not limited to Internet.

After transmitting selection information with respect to media content to the server according to the foregoing embodiments shown in FIGS. 1 through 6, the user device 100 may receive an SNS based on the selection information from the server.

For example, upon receiving an SNS request signal based on the selection information from the user interface unit 101, the processor 103 transmits the SNS request signal to the server through the second data transmitting and receiving unit 105. Upon receiving an SNS based on selection information from the server through the second data transmitting and receiving unit 105, the processor 103 outputs the received SNS information to the user interface unit 101. The received SNS information may be SNS information based on selection information with respect to media content, which is irrelevant to the selection information with respect to the media content transmitted from the user device 100 to the server.

Thus, without the need to transmit selection information with respect to media content to the server, the user device 100 may receive an SNS based on selection information with respect to media content from the server. The processor 103 may define the embodiments shown in FIGS. 2 through 6 to further include receiving an SNS based on selection information with respect to media content from the server in response to a user's request received through the user interface unit 101, or may define a flowchart based on receiving an SNS based on selection information with respect to media content from the server, independent of FIGS. 2 through 6.

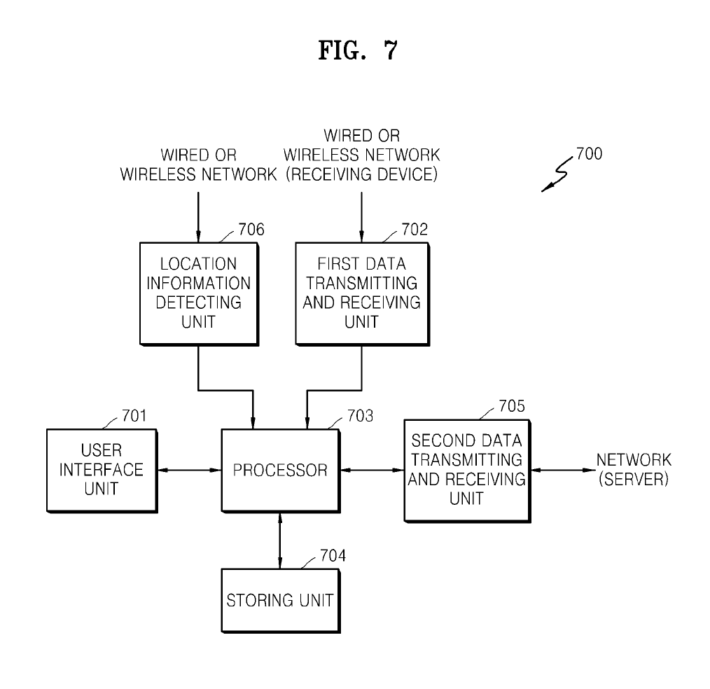

FIG. 7 is a block diagram of a user device 700, according to another embodiment of the present invention. The user device 700 has a location information detection function in addition to functions of the user device 100 of FIG. 1. A user interface unit 701, a first data transmitting and receiving unit 702, a storing unit 704, and a second data transmitting and receiving unit 705, shown in FIG. 7, may be structured and may operate in the same manner as the user interface unit 101, the first data transmitting and receiving unit 102, the storing unit 104, and the second data transmitting and receiving unit 105, shown in FIG. 1.

A location information detecting unit 706 may detect location information of the user device 700, and is not limited to, based on a Global Positioning System (GPS) signal received through a wired or wireless network or base station information (e.g., cell IDentification (ID) information). The detected location information is transmitted to a processor 703.

The processor 703 may transmit the location information of the user device 700 received from the location information detecting unit 706 to a server, when transmitting second information about selected media content to the server through the second data transmitting and receiving unit 705, as shown in FIG. 1. The location information may be stored in the storing unit 704, but may also be temporarily stored in the processor 703.

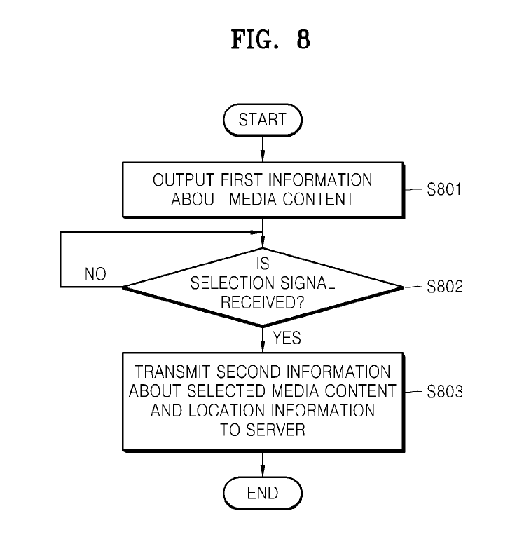

The processor 703 may manage selection information with respect to media content based on a loaded program as shown in FIG. 8. FIG. 8 is a flowchart illustrating a method of managing selection information with respect to media content in the user device 700, according to another embodiment of the present invention.

In FIG. 8, a function of transmitting the location information of the user device 700 is added to the embodiment illustrated in FIG. 2. Blocks S801 and S802 of FIG. 8 are the same as blocks S201 and S202 of FIG. 2, and thus, will not be described again.

In block S803, the processor 703 transmits the location information received from the location information detecting unit 706 to the server when transmitting the second information about the selected media content to the server.

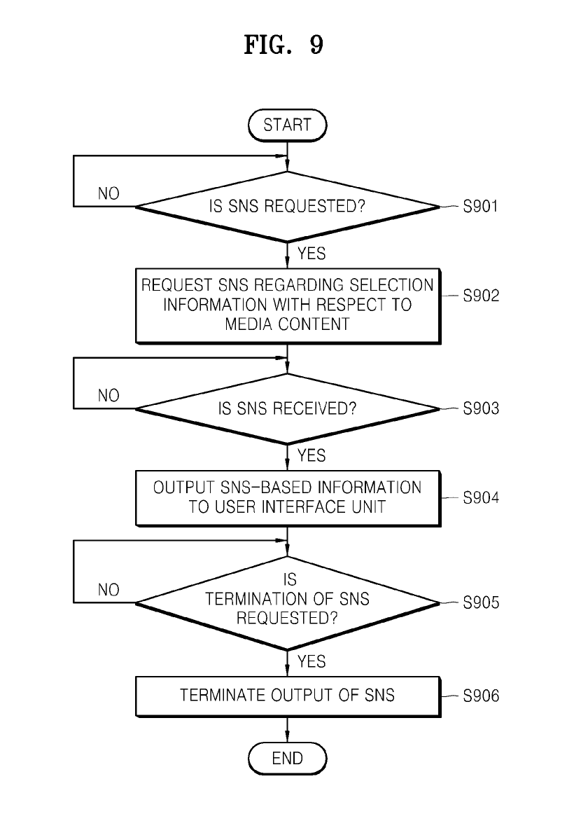

The processor 703 may perform an SNS based on selection information with respect to media content according to a loaded program, as shown in FIG. 9. FIG. 9 is a flowchart illustrating an SNS method for selection information with respect to media content in the user device 700, according to another embodiment of the present invention. The method of FIG. 9 may be included in the embodiment illustrated in FIG. 8.

Referring to FIG. 9, upon receiving an SNS request signal regarding selection information with respect to media content from the user interface unit 701 in block S901, the processor 703 requests the server to transmit an SNS regarding the selection information in block S902. The processor 703 may request the server to transmit an SNS based on location information of the user device 700.

Upon receiving the SNS regarding the selection information from the server in block S903, the processor 703 outputs SNS-based information to the user interface unit 701 to allow the user to use the SNS-based information in block S904.

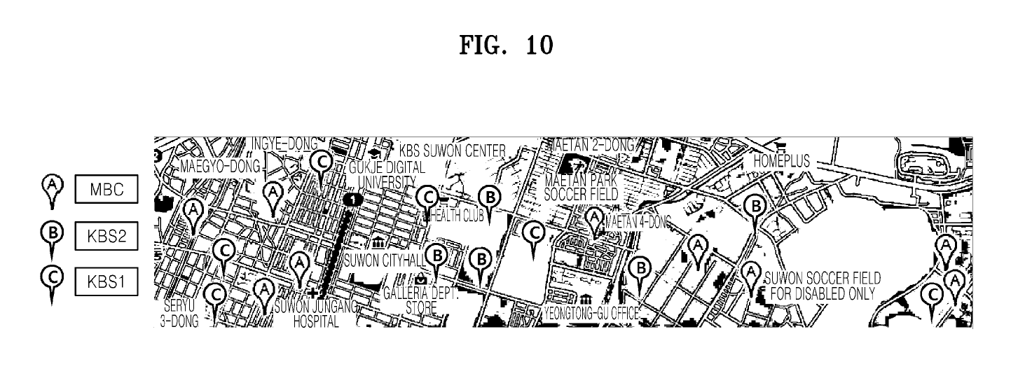

If the SNS-based information output to the user interface unit 701 concerns an audience rating of a broadcasting program based on location information, a screen as shown in FIG. 10 may be output to the user interface unit 701. FIG. 10 shows an SNS screen regarding audience states of broadcasting programs of broadcasting stations, MBC, KBS2, and KBS1 in a neighboring area around a current location of the user device 700. The audience ratings of the broadcasting programs may be, but are not limited to, a consumption behavior or consumption pattern of media content. The location of the user device 700 in FIG. 10 may be based on location information provided from the user device 700. However, the SNS-based information output in block S904 may be information irrelevant to the location of the user device 700.

Upon receiving an SNS termination request through the user interface unit 701 in block S905, the processor 703 terminates output of the SNS-based information through the user interface unit 701 in block S906. After terminating output of the SNS-based information, the processor 703 may, but is not limited to, proceed to a stand-by state for performing another process.

The user device 100 shown in FIG. 1 and the user device 700 shown in FIG. 7 have a function of receiving information regarding media content from a receiving device and controlling the receiving device. However, the user devices 100 and 700 may also have a function of receiving media content through a wired/wireless network.

If the user devices 100 and 700 have a function of receiving media content, the first data transmitting and receiving unit 102 and 702 included in the user devices 100 and 700, respectively, may be media content receiving units. The media content receiving units may be receiving media content including the first information, or independently media content and the first information. The user interface units 101 and 701 may be reproducing or outputting received media content. When selected media content and currently output media content are not the same as each other, the processors 103 and 703 control the media content receiving units to output selected media content through the user interface units 101 and 701 and the media content receiving units may transmit the received media content directly to the user interface units 101 and 701. Controlling the media content receiving units of the processors 103 and 703 to output the selected media content may be referred as controlling a media content receiving function.

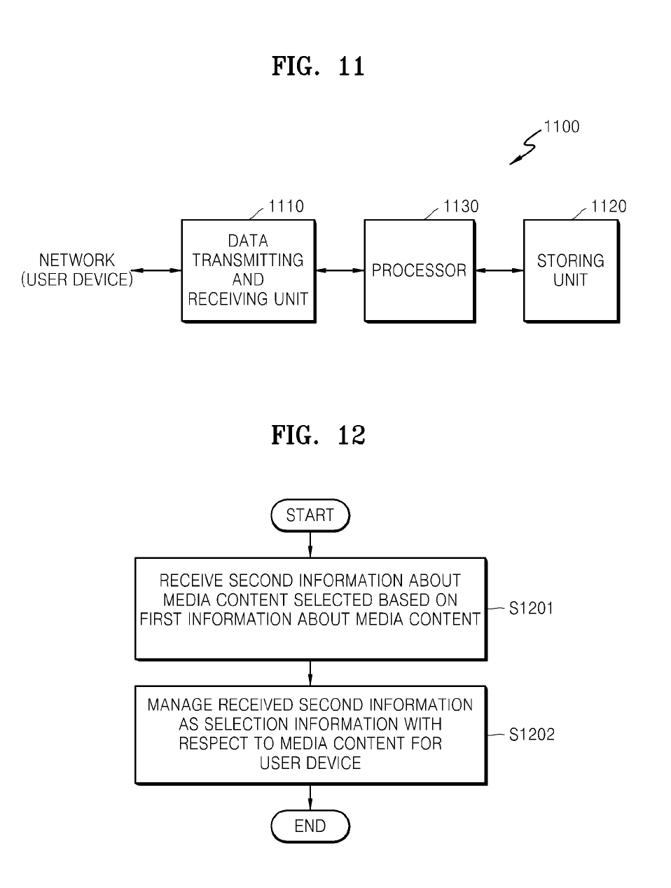

FIG. 11 is a block diagram of a server 1100, according to an embodiment of the present invention. The server 1100 may be a server capable of managing selection information with respect to media content or a server capable of providing an SNS for selection information with respect to media content. The server 1100 is a device capable of connecting to a network, e.g., the Internet, and may use a computer system.

Referring to FIG. 11, the server 1100 may include a data transmitting and receiving unit 1110, a storing unit 1120, and a processor 1130.

The data transmitting and receiving unit 1110 may transmit data to and receive data from at least one user device connected through a network. The storing unit 1120 may store a program capable of managing selection information with respect to at least one media content that can be received by a user device, a program for operating the processor 1130 according to the present invention, and selection information with respect to media content user device-by-user device. The storing unit 1120 may include, but is not limited to, a storage medium such as a flash memory or a hard disk.

Upon receiving second information about media content selected based on first information about at least one media content through the data transmitting and receiving unit 1110, the processor 1130 stores the received second information in the storing unit 1120 as selection information with respect to media content for the user device. The first information and the second information are the same as the first information and the second information mentioned in relation to FIG. 1.

In other words, the processor 1130 may manage the selection information with respect to media content as shown in FIG. 12. FIG. 12 is a flowchart illustrating a method of managing selection information with respect to media content in the 1100 server, according to an embodiment of the present invention.

Referring to FIG. 12, when receiving second information about media content selected based on first information about media content from a user device in block S1201, the processor 1130 stores the received second information in the storing unit 1120 as selection information with respect to media content for the user device.

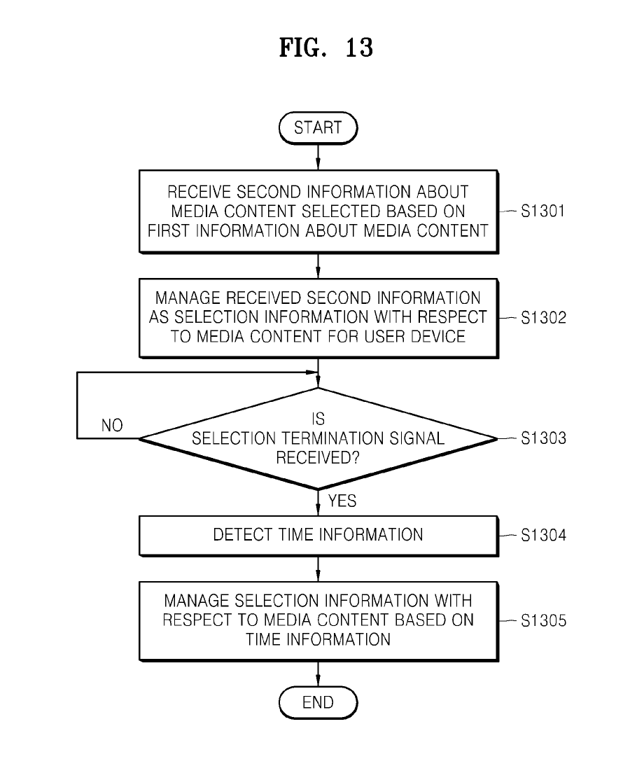

The processor 1130 may manage the selection information with respect to media content as shown in FIG. 13. FIG. 13 is a flowchart illustrating another method of managing selection information with respect to media content in the server 1100, according to an embodiment of the present invention.

In FIG. 13, a function according to reception of a selection termination signal is added to the embodiment illustrated in FIG. 12. Blocks S1301 and S1302 of FIG. 13 are the same as blocks S1201 and S1202 of FIG. 12, and thus will not be described to avoid a repetitive description.

When receiving the selection termination signal from the user device in block S1303, the processor 1130 detects time information about a time from reception of the second information to reception of the selection termination signal in block S1304. The processor 1130 therefore may have a timer function.

Upon detecting the time information, the processor 1130 instructs the storing unit 1120 to store the detected time information and manages selection information stored in the storing unit 1120 based on the detected time information in block S1305. Specifically, the processor 1130 may manage the selection information stored in the storing unit 1120 based on the detected time information to improve reliability of information about a user's consumption behavior of media content. In other words, based on the time information, the processor 1130 may recognize whether the user, after selecting media content, substantially reproduces or outputs the selected media content. Thus, the processor 1130 may provide to the user device an SNS based on information about whether the user merely selects media content or substantially outputs or reproduces the selected media content. Alternatively, the processor 1130 may provide to the user device an SNS based on information about media content that is output or reproduced for a predetermined time or more, excluding information about media content which is merely selected by the user.

The processor 1130 may variously classify reward information for a user device, which provides selection information with respect to media content based on the time information, and provide the reward information to the user device. The reward information is information indicating benefits that the server 1100 provides to the user device, which provides selection information with respect to media content. For example, the processor 1130 may provide the reward information to the user device based on the time information, by incrementing a point of the user device each time media content is selected or providing an on-line badge to the user device according to a selection pattern of media content.

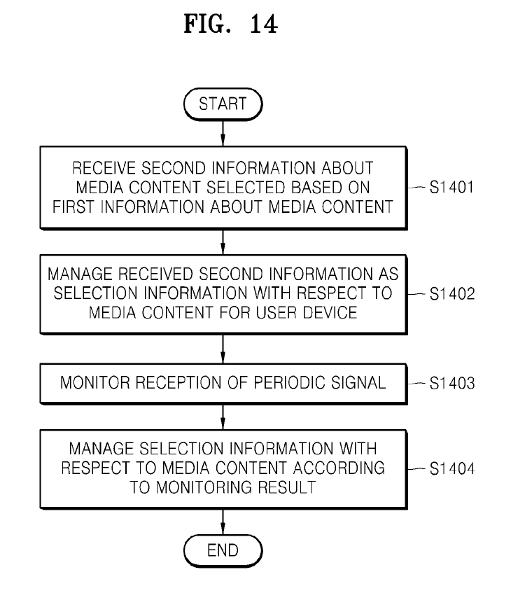

The processor 1130 may manage selection information with respect to media content as shown in FIG. 14. FIG. 14 is a flowchart illustrating an additional method of managing selection information with respect to media content in the server 1100, according to an embodiment of the present invention.

In the embodiment illustrated in FIG. 14, blocks S1303 through S1305 of FIG. 13 are modified to manage selection information with respect to media content based on a periodic signal. Blocks S1401 and S1402 of FIG. 14 are the same as blocks S1301 and S1302 of FIG. 13, and thus, will not be described again.

Referring to FIG. 14, in block S1403, the processor 1130 monitors reception of the periodic signal from the user device that transmits the second information. The periodic signal is a signal indicating maintenance of selection of media content based on an output state of the selected media content, as described with reference to FIG. 4.

In block S1404, the processor 1130 manages selection information with respect to media content according to the monitoring result. Specifically, if the monitoring result indicates reception of the periodic signal, the processor 1130 may determine that output of the selected media content is maintained, and thus, manage the selection information with respect to the media content stored in the storing unit 1120 as shown in FIG. 13. On the other hand, if the monitoring result indicates non-reception of the periodic signal, the processor 1130 may determine that the output of the selected media content is not maintained, and thus, manage the selection information with respect to the media content stored in the storing unit 1120, as shown in FIG. 13.

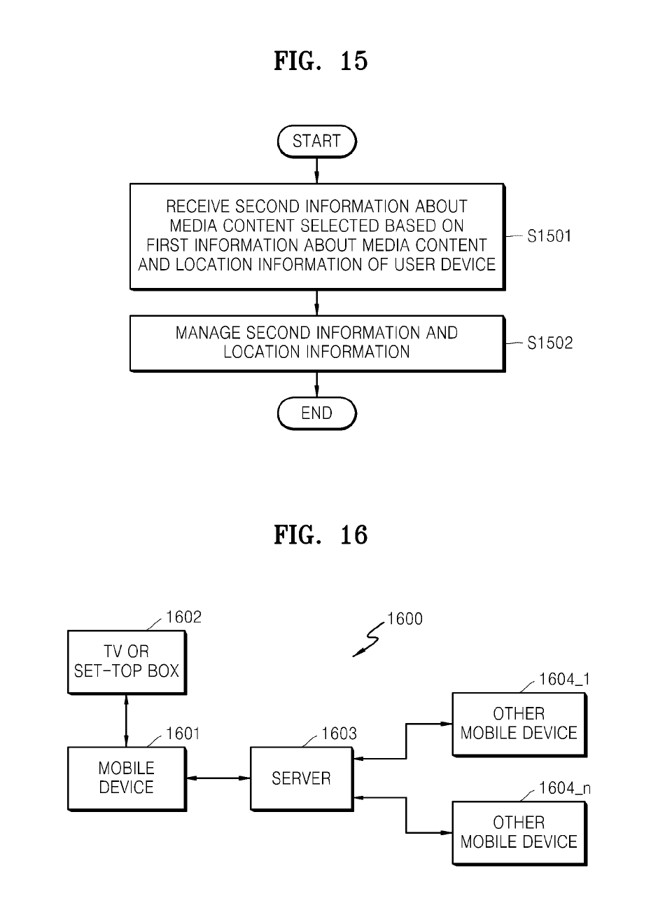

FIG. 15 is a flowchart illustrating a method of managing selection information with respect to media content in the server 1100, according to an embodiment of the present invention.

In FIG. 15, a function according to reception of location information is added to the embodiment illustrated in FIG. 12.

Upon receiving the second information about the media content selected based on the first information and the location information of a user device from the user device in block S1501, the processor 1130 stores the received location information and second information together in the storing unit 1120 to manage them as selection information with respect to media content for the user device in block S1502.

Thus, upon receiving an SNS request signal for selection information with respect to media content based on location information from a user device through the data transmitting and receiving unit 1110, the processor 1130 provides an SNS regarding location-based selection information with respect to media content stored in the storing unit 1120 to the user device requesting the SNS through the data transmitting and receiving unit 1110. The SNS provided to the user device may be defined as an SNS based on location information of the user device requesting the SNS or selection information with respect to media content collected from at least one user device included in a social network being set based on the user device requesting the SNS. However, the user device requesting the SNS may request the server to transmit the SNS based on selection information with respect to media content, irrespective of the physical location information of the user device.

The embodiment illustrated in FIG. 15 may be modified to further include a function of managing selection information with respect to media content based on time information, according to reception of the selection termination signal as shown in FIG. 13.

The user device 100 shown in FIG. 1 operating based on FIGS. 2 through 6, the user device 700 shown in FIG. 7 operating based on FIGS. 8 and 9, and the server 1100 shown in FIG. 11 operating based on FIGS. 12 through 15 can be applied to a network system 1600 shown in FIG. 16. FIG. 16 illustrates the network system 1600 including the user device 100 or 700 and the server 1100, according to an embodiment of the present invention.

A mobile device 1601 shown in FIG. 16 corresponds to the user device 100 shown in FIG. 1 or the user device 700 shown in FIG. 7. A TV or set-top box 1602 corresponds to a receiving device capable of receiving at least one media content, and a server 1603 corresponds to the server 1100 shown in FIG. 11. Thus, the mobile device 1601 not only receives information about at least one media content from the TV or set-top box 1602, but also controls output of the TV or set-top box 1602 in association with the selected media content.

The server 1603 may manage selection information with respect to media content collected from the mobile device 1601 in a manner described in FIGS. 12 through 15, and may provide an SNS for sharing the collected selection information with other mobile devices 1604_1 and 1604_{—}n or sharing selection information with respect to media content collected from the mobile devices 1604_1 and 1604_{—}n with the mobile device 1601. The server 1603 may provide an SNS regarding selection information with respect to media content based on location information of the mobile device 1601 as described with reference to FIG. 15.

When the mobile device 1601 shown in FIG. 16 has a terrestrial DMB receiving function, a satellite DMB receiving function, or a media content receiving function, the TV or set-top box 1602 may be excluded from FIG. 16. If the TV or set-top box 1602 shown in FIG. 16 includes a processor which may connect to the server 1603 and thus perform the above-described function of the processor 103 shown in FIG. 1 or the processor 703 shown in FIG. 7, the mobile device 1601 may be excluded from FIG. 16 and the TV or set-top box 1602 may be connected to the server 1603 through a network. The other mobile devices 1604_1 and 1604_{—}n may be defined as other TV or set-top boxes.

The method of managing selection information with respect to media content in the user device or the program for executing the method of managing selection information with respect to media content in the server device according to the present invention may be embodied as a computer-readable code on a computer-readable recording medium. The recording medium may be all kinds of recording devices storing data that are readable by a computer. Examples of the recording medium include Read-Only Memory (ROM), Random Access Memory (RAM), CD-ROMs, magnetic tapes, floppy disks, and optical data storage devices. The computer-readable recording medium can also be distributed over a network of coupled computer systems so that the computer-readable code is stored and executed in a decentralized fashion.

While the invention has been shown and described with reference to certain embodiments thereof, it will be understood by those of ordinary skill in the art that various changes in form and detail may be made therein without departing from the spirit and scope of the present invention as defined by the following claims. Accordingly, the embodiments of the present invention should be considered in an illustrative sense not in a limiting sense. The scope of the present invention is defined not by the detailed description of the present invention but by the appended claims, and all differences within the scope will be construed as being included in the present invention.

What is claimed is:

1. A method of managing selection information with respect to media content in a user device, the method comprising the steps of:
outputting first information about at least one media content from the user device;
receiving a selection signal based on the first information at the user device; and
transmitting second information about media content selected by the selection signal from the user device to a server.

2. The method of claim 1, further comprising transmitting a selection termination signal regarding the selected media content to the server, when output of the selected media content is terminated.

3. The method of claim 1, further comprising transmitting location information of the user device from the user device to the server.

4. The method of claim 1, further comprising receiving a Social Network Service (SNS) regarding the selection information with respect to the media content, wherein the SNS is managed by the server.

5. The method of claim 1, further comprising, after transmitting the second information to the server, periodically transmitting a signal indicating maintenance of selection of the media content from the user device to the server until an output state of the selected media content is changed.

6. The method of claim 1, further comprising:
comparing the media content selected by the selection signal with currently output media content; and
when the selected media content is different from the currently output media content, controlling a media content receiving function to output the selected media content.

7. The method of claim 1, wherein the first information comprises identification information of the at least one media content and the second information comprises identification information of the selected media content.

8. The method of claim 1, wherein the at least one media content is media content received in real time.

9. The method of claim 1, wherein the user device is a mobile device.

10. The method of claim 1, wherein the at least one media content is received by a receiving device connected to the user device.

11. A method of managing selection information with respect to media content in a server, the method comprising the steps of:
receiving second information about media content selected based on first information about at least one media content at the server from a user device; and
managing, at the server, the received second information as selection information with respect to the at least one media content for the user device.

12. The method of claim 11, further comprising:
when receiving a selection termination signal regarding the selected media content at the server from the user device, detecting time information from reception of the second information until reception of the selection termination signal; and
managing, at the server, the selection information with respect to the at least one media content based on the time information.

13. The method of claim 11, further comprising receiving location information of the user device, wherein the management of the selection information comprises managing location information of the user device together with the selection information with respect to the at least one media content.

14. The method of claim 11, further comprising providing a Social Network Service (SNS) based on the selection information with respect to the media content from the server to the user device.

15. The method of claim 11, further comprising monitoring periodic reception of a signal indicating maintenance of selection of the media content after receiving the second information, wherein the management of the selection information comprises using a result of the monitoring when managing the selection information.

16. The method of claim 11, wherein the first information comprises identification information of the at least one media content and the second information comprises identification information of the selected media content.

17. A user device comprising:
a first data transmitting and receiving unit for receiving first information about at least one media content;
a user interface unit for interacting with a user;
a second data transmitting and receiving unit for transmitting and receiving data with a server;
a storing unit for storing a program for managing user's selection information with respect to the at least one media content; and
a processor for outputting the first information received by the first data transmitting and receiving unit to the user interface unit, and, upon receiving a selection signal based on the output first information from the user interface unit, transmitting second information about media content selected by the selection signal to the server through the second data transmitting and receiving unit.

18. The user device of claim 17, wherein, when output of the selected media content is terminated, the processor transmits a selection termination signal regarding the selected media content to the server through the second data transmitting and receiving unit.

19. The user device of claim 17, wherein the processor periodically transmits a signal indicating maintenance of selection of the media content to the server until an output state of the selected media content is changed, after transmitting the second information to the server.

20. The user device of claim 17, further comprising a location information detecting unit detecting location information of the user device, wherein the processor transmits the location information to the server through the second data transmitting and receiving unit.

21. The user device of claim 17, wherein if a Social Network Service (SNS) regarding the selection information with respect to the media content is requested through the user interface unit, the processor outputs SNS-based information regarding the selection information with respect to the media content received from the server through the second data transmitting and receiving unit.

22. The user device of claim 17, wherein the processor compares the media content selected by the selection signal with currently output media content, and controls a media content receiving function to output the selected media content if the selected media content is different from the currently output media content.

23. The user device of claim 17, wherein the first information comprises identification information of the at least one media content and the second information comprises identification information of the selected media content.

24. The user device of claim 17, wherein the media content is media content received in real time.

25. The user device of claim 17, wherein the media content is received by a receiving device connected to the user device.

26. A server comprising:
a data transmitting and receiving unit for transmitting and receiving data with at least one user device;
a storing unit for storing selection information with respect to at least one media content; and
a processor for, upon receiving second information about media content selected based on first information about the at least one media content through the data transmitting and receiving unit, instructing the storing unit to store the received second information as the selection information.

27. The server of claim 26, wherein, upon receiving a selection termination signal regarding the selected media content from the user device through the data transmitting and receiving unit, the processor detects time information from reception of the second information until reception of the selection termination signal, instructs the storing unit to store the detected time information, and manages the selection information based on the time information.

28. The server of claim 26, wherein, upon receiving location information of the user device, the processor instructs the storing unit to store the location information and manages the selection information based on the location information.

29. The server of claim 26, wherein, when a Social Network Service (SNS) regarding the selection information with respect to the media content is requested from the user device through the data transmitting and receiving unit, the processor provides the SNS to the user device by using the selection information stored in the storing unit.

30. The server of claim 26, wherein the processor monitors periodic reception of a signal indicating maintenance of selection of the media content after receiving the second information, and manages the selection information by using a result of the monitoring.

31. The server of claim 26, wherein the first information comprises identification information of the at least one media content and the second information comprises identification information of the selected media content.

32. A storage medium having recorded thereon a computer program for executing a method of managing selection information with respect to media content in a user device, the computer program executing the steps of:
outputting first information about at least one media content from the user device;
receiving a selection signal based on the first information at the user device; and
transmitting second information about media content selected by the selection signal from the user device to a server.

33. A storage medium having recorded thereon a computer program for executing a method of managing selection information with respect to media content in a server, the computer program executing the steps of:
when receiving a selection termination signal regarding the selected media content at the server from the user device, detecting time information from reception of the second information until reception of the selection termination signal; and
managing, at the server, the selection information with respect to the at least one media content based on the time information.
